(19) United States
(12) Patent Application Publication
(10) Pub. No.: US 2007/0256139 A1
(43) Pub. Date: Nov. 1, 2007

(54) SYSTEM AND METHOD OPERATIVE TO IMPLEMENT A SECURE, SELF-CONTAINED NETWORK

(76) Inventors: Maria Gaos, Bothell, WA (US); Nazih Youssef, Bothell, WA (US)

Correspondence Address: AXIOS LAW GROUP. PLLC, 1525 FOURTH AVENUE, SUITE 800, SEATTLE, WA, 98101, US

(21) Appl. No.: 11/743,142

(22) Filed: May 1, 2007

Related U.S. Application Data
(60) Provisional application No. 60/746,138, filed on May 1, 2006.

(51) Int. Cl. H04L 9/32; H04N 7/16; G06K 9/00; G06F 17/30; G06F 7/04; H03M 1/68; H04K 1/00; H04L 9/00

(52) U.S. Cl. 726/26; 726/27; 726/28; 726/2

(57) ABSTRACT

A system operative to implement a secure self-contained network comprising a plurality of operation and control centers comprising the secure self-contained network, a plurality of client devices coupled to the operation and control centers, each client device operative to monitor user actions and to compile data based on the actions, and a data repository coupled to the plurality of operation and control centers, at least a first group of the plurality of operation and control centers operative to categorize the compiled data based on the monitored user actions and the data repository being operative to determine the relevance of the compiled data.

### CROSS-REFERENCE TO RELATED APPLICATIONS

This application is based upon and claims the benefit of priority from Provisional Application No. 60/746,138 filed May 1, 2006, the entire contents of which are incorporated herein by reference.

### FIELD

The present disclosure relates generally to computing and communications, and in particular but not exclusively, relates to an operating environment having the capability to enable secure and private computing and communications between geographically dispersed electronic devices and to reason about the computing and communications needs of users of the electronic devices based on their uses of these devices.

### BACKGROUND

A growing number of electronic devices are being developed to facilitate communication among a rapidly growing number of users in distributed locations around the world using the Internet and other communication networks as the computing and communications infrastructure. Initially, the Internet was conceived as a means for facilitating communications among major research centers involved in various types of government funded research. This traditionally confined communications medium was suddenly and abruptly made available to users of computing and communications devices around the world with the advent of the World Wide Web. The hypertext linking made available by the user interface paradigm established by the World Wide Web required use of the existing computing and communications infrastructure that had been developed previously only for use among these research centers. This infrastructure has since come to be referred to as the Internet, which in practical terms consists of a network of networks that are geographically dispersed around the world.

These networks, however, were never intended to be used as a computing and communications infrastructure for communications requiring varying levels of security and privacy. Indeed, both security and privacy are major concerns for manufacturers of electronic devices and appliances intended to be used not only by the general public but by corporations and government officials. The apparent “liberation” of the governmental computing and communications infrastructure that has since come to be referred to as the Internet now requires serious modifications if information security and privacy are to be provided. The dramatic growth in the myriad of electronic devices and software applications that use the Internet as a means for communications and distributed computing is noteworthy, but the looming fear of the loss of information security and privacy is equally as daunting.

A number of attempts have been made to improve the security of information flows across the networks comprising the Internet. However, the fundamental problem still remains that the Internet is an open communications environment and little can be done to preserve data security and information privacy. This challenge associated with this operating environment is not new and a number of attempts have been made to improve both data security and information privacy.

Indeed, the packet switched environment of the Internet has been used advantageously by others to enhance information security by encrypting transmitted packets according to various mathematical algorithms. A variety of encryption algorithms have been developed and implemented by industry. Public key encryption is an example of one such data encryption approach which can be used on a variety of computing and communications networks including the Internet to enhance data security. However, public key encryption methods are still susceptible to traffic pattern analysis and man-in-the-middle attacks.

Attempts to improve information privacy have had varying success in the past. Often it is difficult, if not impossible, to effectively transmit private information securely on the same channels as non-private information on an open global communications network without significant computing overhead or increased bandwidth requirements.

Although much work has been done in the field of communications to increase channel efficiency and bandwidth, especially by approaches involving time division multiple access, frequency division multiple access and code division multiple access methods, only in rare instances have these methods been combined with a data security approach to enhance the overall security and privacy of communications over an otherwise public, unrestricted medium like the Internet.

Furthermore, in computing and communications networks in which information is to be gathered for the purpose of monitoring application usage patterns and other user specific information, significant amounts of information must often be compiled. Few, if any, attempts have been made to implement computing and communications networks that can reason inferentially about the current and anticipated application and computing needs of users on a geographically dispersed network while also limiting the amount of information that can be compiled to determine the nature and types of applications used by these users so as to preserve and enhance information privacy and data security.

Thus, there is a great need for a system and method that can provide information privacy and data security on any number of communication networks to enable users of electronic devices to rapidly and efficiently transmit sensitive and possibly secure user-specific information to and among other electronic devices. Additionally, there is a need for a system and method that are capable of reasoning about and inferring usage of the computing and communications resources needed by each user of electronic devices that are coupled to a geographically dispersed network.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram of a computing infrastructure comprised of multi-regions for a distributed network of control and operation centers in an embodiment.

FIG. 2 is a block diagram of a computing infrastructure comprised of super regions for a distributed network of control and operation centers in an embodiment.

FIG. 3 is a block diagram of a computing infrastructure comprised of mega-regions for a distributed network of control and operation centers in an embodiment.

FIG. 4 is a flow chart for a process of analyzing user actions in an embodiment.

FIG. 5A is a flow chart for a process of authenticating a user identity and monitoring user actions on a client device in an embodiment.

FIG. 5B is a flow chart for a speech process for monitored user actions in an embodiment.

FIG. 6A is a flow chart for a process of requesting communication from a client device and sorting recognized and unrecognized information in an embodiment.

FIG. 6B is a flow chart for a process of data association in an embodiment.

FIG. 6C is a flow chart for a process of group correlation and data analysis in an embodiment.

FIG. 6D is a flow chart for a process of event and item data analysis in an embodiment.

FIG. 6E is an illustration of the common data file content provided in an embodiment.

FIG. 7 is a flow chart for a process of multi-level data compilation in an embodiment.

FIG. 8 is a flow chart for a process of data analysis and storage of common data and pertinence data in an embodiment.

FIG. 9 is a flow chart for a process of data analysis to determine common sense and pertinent sense data in an embodiment.

FIG. 10A is an illustration of a conventional centrally controlled network.

FIG. 10B is an illustration of a conventional decentralized network.

FIG. 10C is an illustration of a computing infrastructure including a secure, self-contained network in an embodiment.

### DETAILED DESCRIPTION

Embodiments of techniques to implement a distributed computing and communications system, for example, a secure, intelligent network that is capable of acknowledging, recognizing and adapting to a user's behaviors and habits while preserving information privacy are described herein. In the following description, numerous specific details are given to provide an understanding of embodiments. The aspects disclosed herein can be practiced without one or more of the specific details, or with other methods, components, etc. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A preferred aspect provides for a highly distributed, secure and intelligent network that monitors human user interactions with enabled client devices or set-top boxes coupled to the network to determine patterns in such interactions. Enabled client devices include devices having custom-designed modules, general purpose modules adapted for use and integration with the network, or a combination of both custom-designed modules and specially adapted general purpose modules. Among the different type of client devices are televisions, desktop computers, portable computers, smart phones, personal digital assistants, set-top boxes and various audiovisual streaming devices (e.g., DVD players, video gaming platforms, etc.). In an embodiment, enabled client devices or set-top boxes are each coupled to the network through a platform module providing routing and secure access capabilities. Based on well-established research, it has been known that humans learn through repetition and association. In view of such research, the enabled client devices or set-top boxes coupled to the network actively monitor user actions, form dynamic associations and categories for such actions, and build dynamic user profiles that are stored locally within memories in the enabled client devices or the set-top boxes to constantly monitor and discern what actions may ultimately be deemed long-term behaviors and habits.

These enabled client devices also include controllable access restrictions, or in an alternative embodiment, are coupled to an external controllable access restriction device. The embedded access restrictions as well as the alternative external access restriction devices can be controlled from within the network by one or more operation and control centers, or from servers external to the self-contained network. In an embodiment, the access restrictions are used to implement reciprocal access control restrictions that enable client devices to be recognized by the network and to be considered part of the secure network. Establishing reciprocal access is the process by which a client device is included in the network and allowed to have access to internal network resources, such as data in the operation and control centers. In yet a different embodiment, multiple regions of computing and communications exist which are managed through regional operations and control centers. A “geographic region” is comprised of a collection of “geographic locations.” A “multi-region” is comprised of a collection of geographic regions, a “super region” is comprised of a collection of multi-regions, a “mega-region” is comprised of a collection of super regions and a worldwide network exists in this computing network to provide computing and infrastructure support for a collection of “mega-regions.”

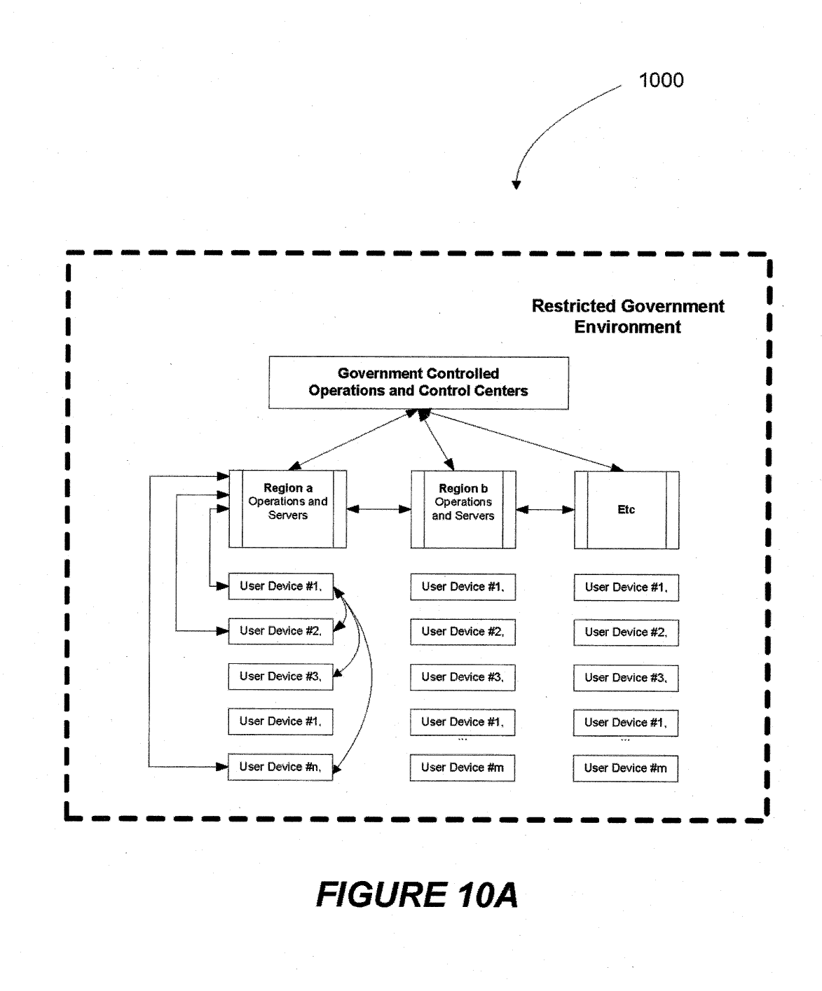

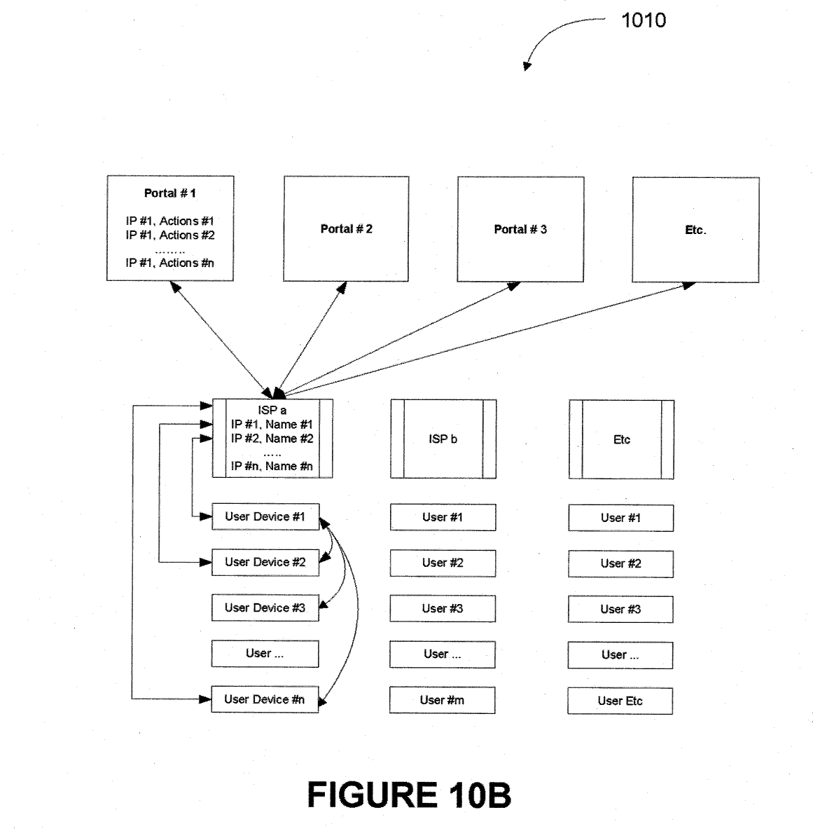

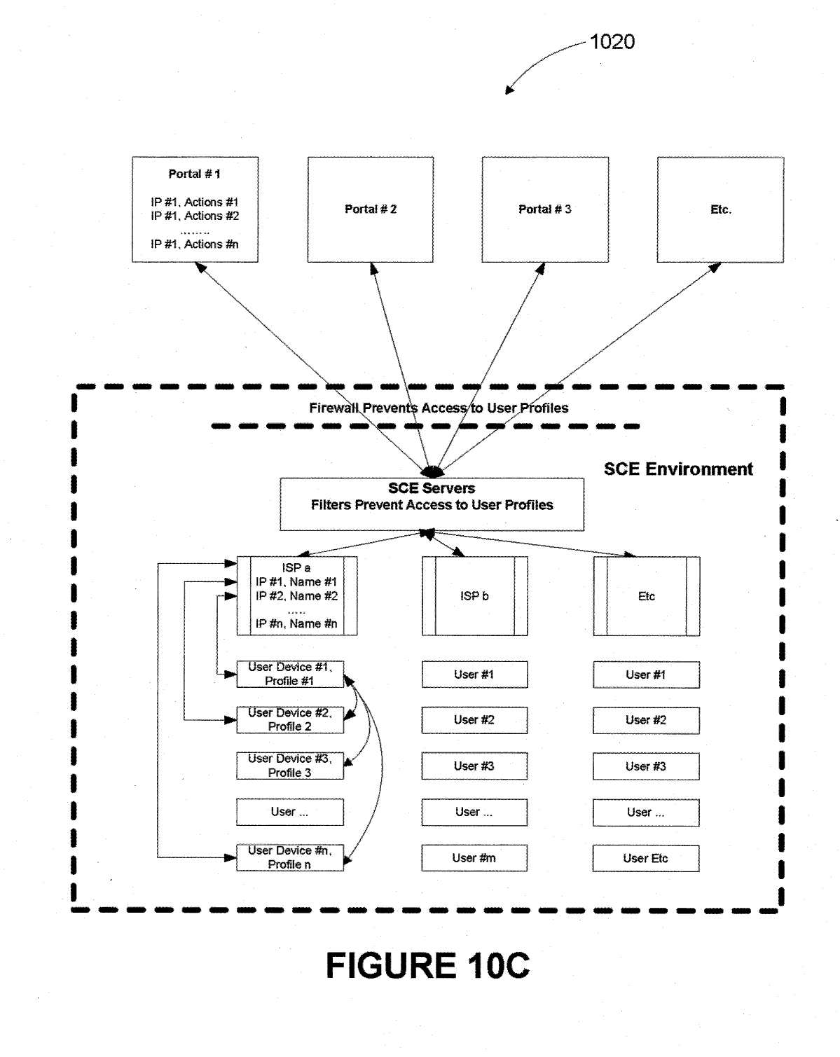

FIG. 10A is an illustration of a conventional centrally controlled computer network 1000 that includes operation and control centers and multiple user devices. In this network, a restricted government computer environment limits the type and degree of access users of the user devices have to external resources.

In contrast, FIG. 10B is an illustration of a different conventional network that is highly decentralized and includes multiple independent Internet Service Providers 1010. These Internet Service Providers have independent authority to manage the computing and communications needs of a designated group of user devices. In turn, the ISPs provide unlimited access to various resources on the Internet, as well as other networks, without regard to any given user's specific desires and/or wants for privacy or enhanced security. Essentially, privacy and security are managed on a per transaction level through various conventional protocols.

FIG. 10C is a representative embodiment for the present disclosure that depicts a secure, self-contained environment 1020 (also known as a “Self-Contained Environment” or SCE) which restricts communications between resources beyond the environment (e.g., Portal 1, Portal 2, Portal 3, etc.) and the user devices and service provides within the secure environment. The security policies enforced in the SCE environment create an effective firewall between the secure environment and the external resources. In addition, the multiple levels of servers in the environment provide additional filtering of information to enable controllable restricted access to external resources. The servers (or internal operation and control centers) also restrict external devices in their access to resources within the secure environment. Private users in this type of environment have maximum control over the definition and use of their individual private information.

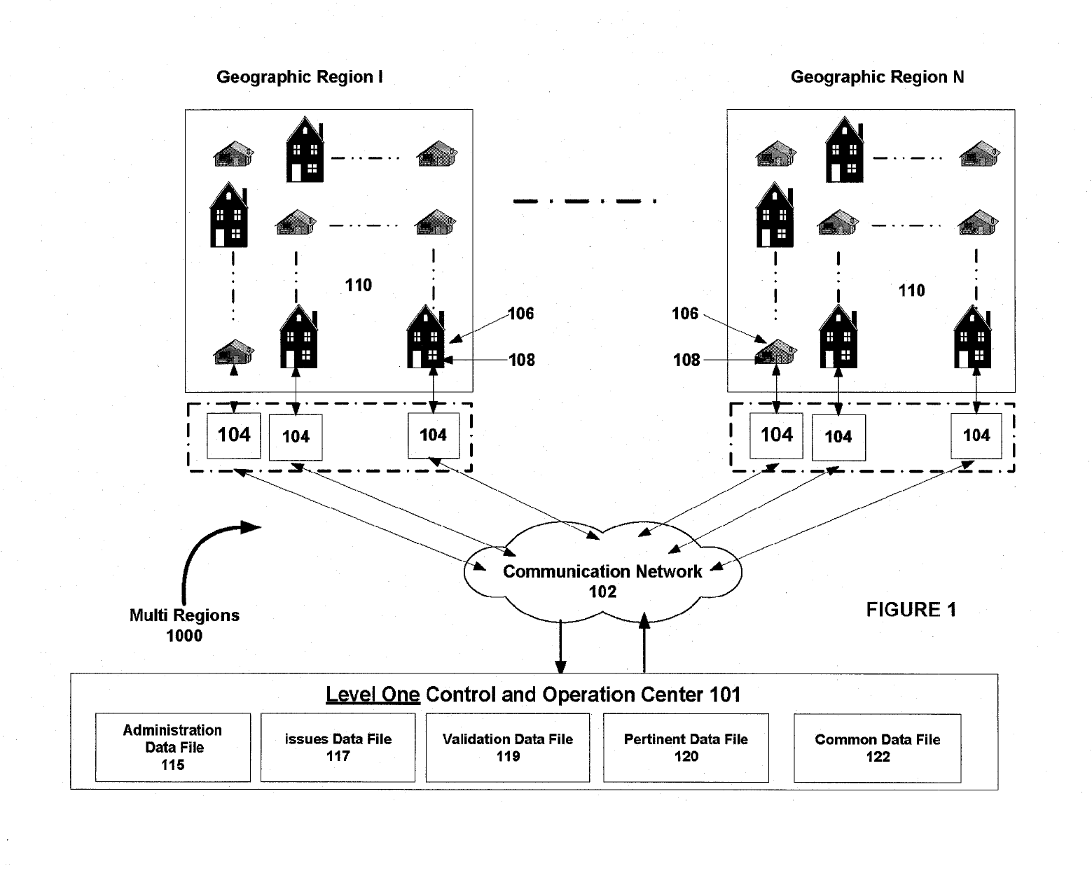

In a more detailed view of the server network, FIG. 1 includes a block diagram which illustrates the lowest level of computing coverage in a secure intelligent network. As shown in this figure, a geographic region is comprised of a plurality of geographic locations which are typically households or individual building locations. As shown here, Geographic Region I includes a plurality of households 106. Each household 106 is depicted as having a set-top box or enabled client device 108. Geographic region I is supported by computing and communications resources at a Level One Control and Operation Center 101 which communicates to a plurality geographic regions (I thru N) through communication network 102 which in turn provides local computing and communications capabilities to the households 106 and in each geographic location 110 with intermediate processing notes 104. Multiple geographic locations 110 are included in each geographic region (I thru N) and their computing and communication requirements are supported by Level One Control and Operation Center 101. Each geographic region covers different geographic locations. For example, geographic region N includes a different group of households and buildings 106 than those included in geographic region I. Each geographic region, however, includes individual buildings 106 and set-top boxes or enabled client devices 108. Intermediate processing notes 104 facilitate communication to and from each household or building 106 in the geographic regions (I thru N) through communication network 102 to a Level One Control and Operation Center 101. Each Level One Control and Operation Center 101 controls and communicates with a “multi-region” as defined and discussed above.

Each Level One Control and Operation Center 101 provides communication and computing resources to a “multi-region” and is comprised of a CPU (not shown) and a plurality of data files stored in a memory. Stored within the memory of each Level One Control and Operation Center 101 are administration data file 115, issues data file 117, validation data file 119, pertinent data file 120, and common data file 122. The Level One Control and Operation Center 101 monitors and stores data of varying type, all of which are collected from the active monitoring of each user's actions on a device or set-top box 108 included in the households 106 in each Geographic Region (I thru N).

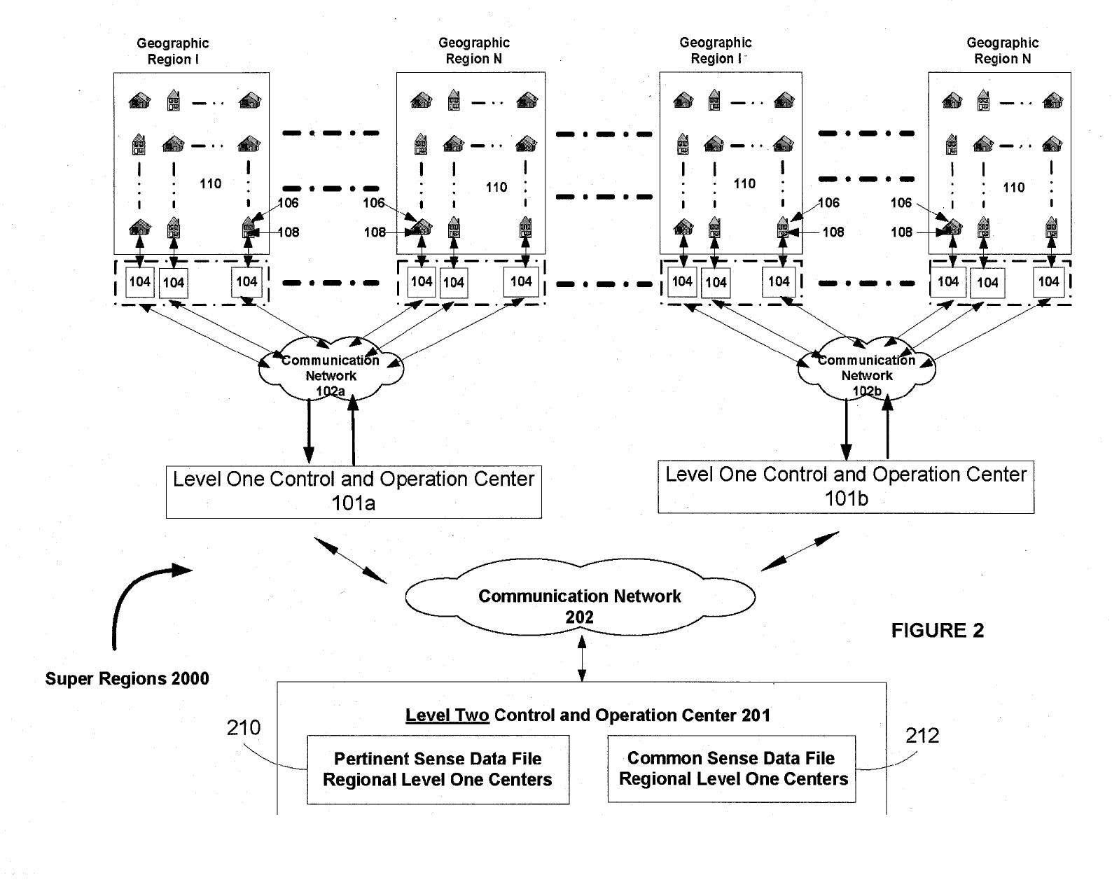

FIG. 2 illustrates the structure and operation of Level One Control and Operation Center 101a and Level One Control and Operation Center 101b, both of which are representative of a plurality of control and operation centers that are actively monitored and controlled by Level Two Operation and Control Center 201. Each of the Level One Control and Operation Centers shown in this figure include all of the data files shown in FIG. 1 for Level One Control and Operation Center 101. The geographic regions controlled and monitored by Level One Control and Operation Center 101a are shown in the far left hand side of FIG. 2 which is a multi-region. The geographic regions shown on the right-hand side of FIG. 2 are included in a different multi-region that is controlled and monitored by Level One Control and Operation Center 101b. Communication networks are used by each control and operation center, indicated here by Communication Network 102a and Communication Network 102b. Other communication networks or sub-networks may be used by other Level One Control and Operation Centers 101 to communicate with other multi-regions in alternative embodiments.

In this network, a super region includes a plurality of Level One Control and Operation Centers 101 and is supported, controlled and actively monitored a Level Two Control and Operation Center 201 through communication network 202. There are multiple Level Two Operation and Control Centers in this intelligent network, each having its own computing and communication resources. Each Level Two Control and Operation Center 201 includes a pertinent data file 210 and a common data file 212. Pertinent data file 210 is a data store that is used to compile the pertinent data retrieved from pertinent data file 120 in each Level One Control and Operation Center 101. Likewise, common data file 212 is a data store for compiling data from each common data file 122 in each Level One Control and Operation Center 101.

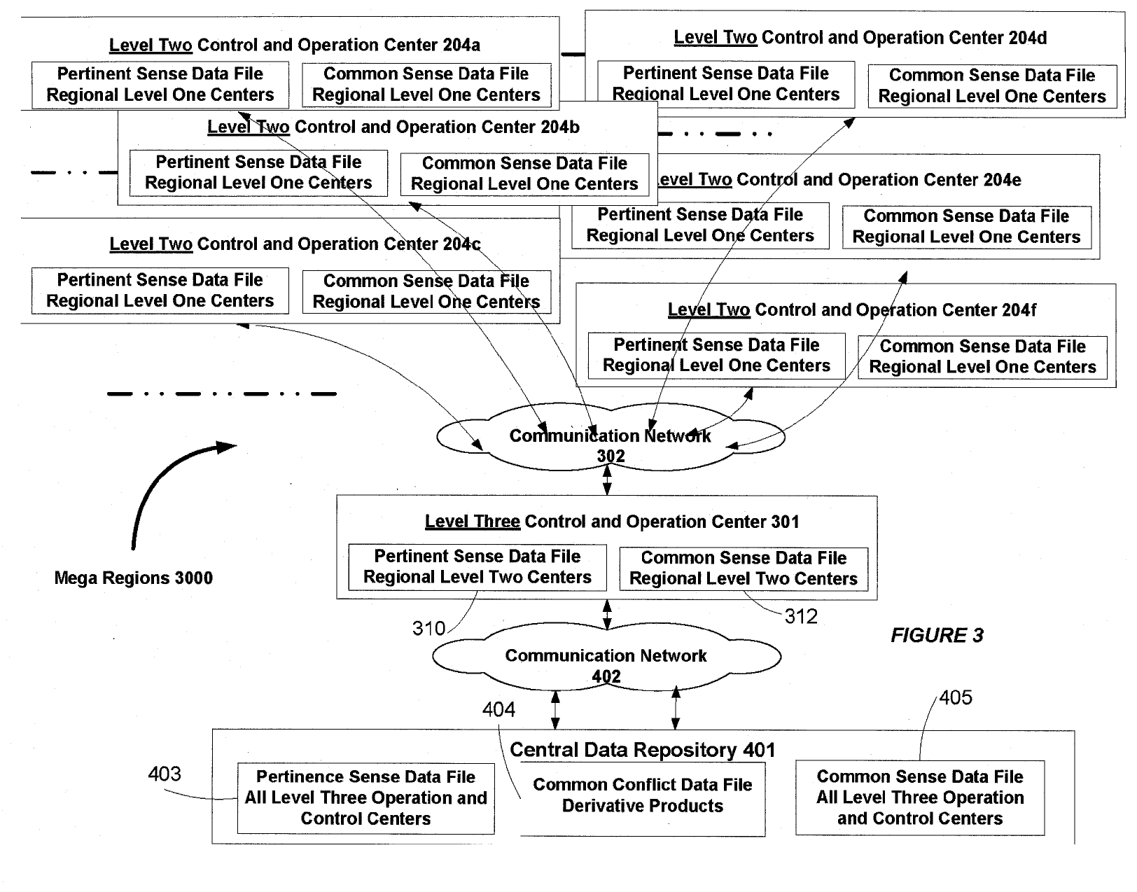

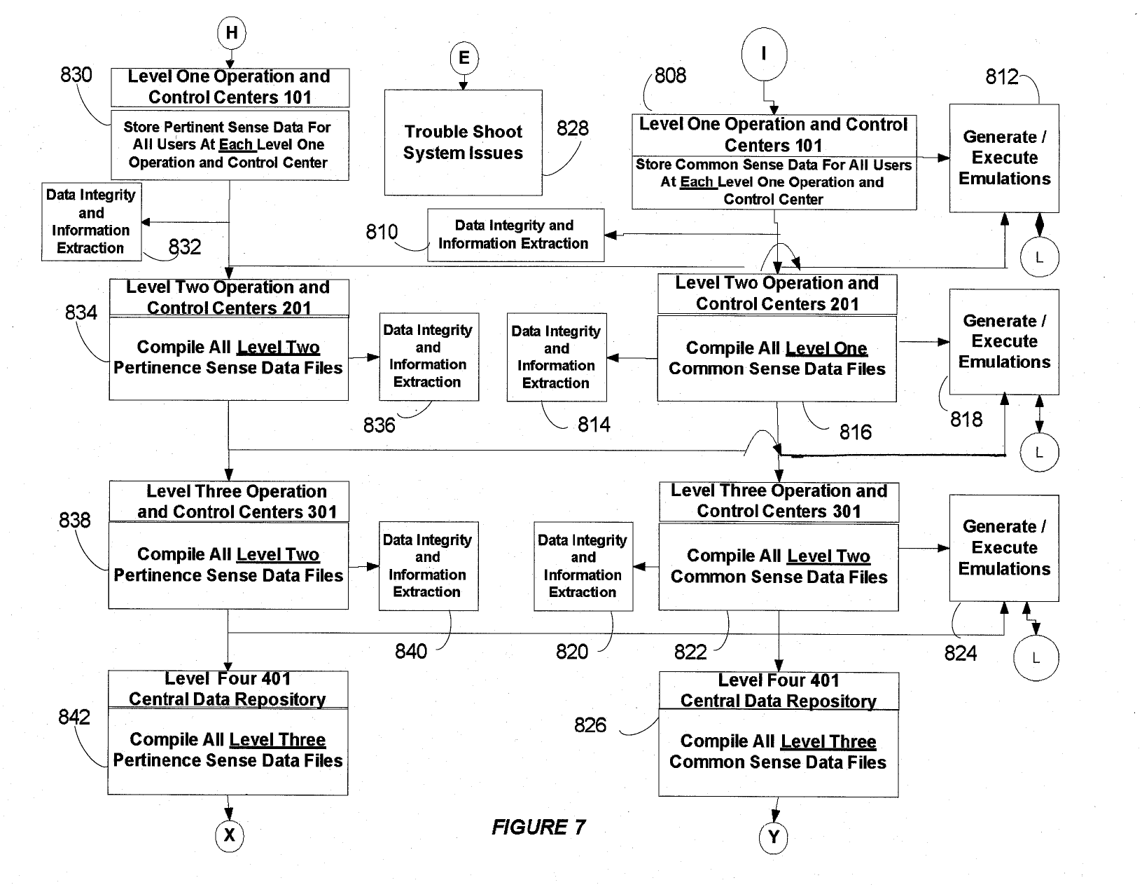

FIG. 3 depicts a plurality of Level Two Control and Operation Centers 201a-201f. Each Level Two Control and Operation Center is shown as including a pertinent data file and a common data file for regional Level One Operation and Control Centers. Level 3 Control and Operation Center 301, including pertinent data file 310 and common data file 312, actively monitors and compiles data from the respective files maintained by Level Two Operation and Control Centers 201 within the mega-region 3000 controlled by Level Three Control and Operation Center 301. Pertinent data file 310 compiles and stores all the pertinent data from each of the pertinent data files maintained by each Level Two Control and Operation Center 201 in the mega-region 3000 controlled by Level Two Control and Operation Center 301. Each Level Three Control and Operation Center communicates over a communication network 402 with a central data repository 401. The central data repository 401 includes a one or more central processing units and memory for storing pertinence data file 403, common conflict data file 404 and common data file 405. Pertinence data file 403 includes a compilation of all data stored and retrieved from each Level Three Control and Operation Center 301 and common conflict data file 404 includes all information pertaining to common operational problems and bases for logical conflicts among generated emulation executed by each of the control and operation centers 101, 201 and 301. Emulation conflict manager 912 actively identifies and stores the common problems and sources of conflict among the emulations (shown in FIG. 7). Common data file 405 includes a compilation of all common data retrieved from each Level Three Controls and Operation Center 301 in the network.

Thus the computing infrastructure of the secure intelligent network has been shown to include four discrete layers of computing and communications capabilities. A plurality of Level One Control and Operation Centers which actively monitor user actions with devices and/or set top boxes and which also performs some preliminary filtering to all data captured from the monitoring process. A plurality of Level Two Operations and Control Centers are provided that compile and store pertinent data and common data retrieved from each Level One Operation and Control Center within super-regions 2000. A plurality of Level Three Control and Operation Centers are provided that monitor and actively compile data from Level Two Control and Operation Centers within each mega-region 3000. A fourth and final level for all data throughout the entire network deemed either pertinent data or a common data or common conflict data is compiled and analyzed within a central data repository 401 which also includes and executes data analysis processes which will be discussed later.

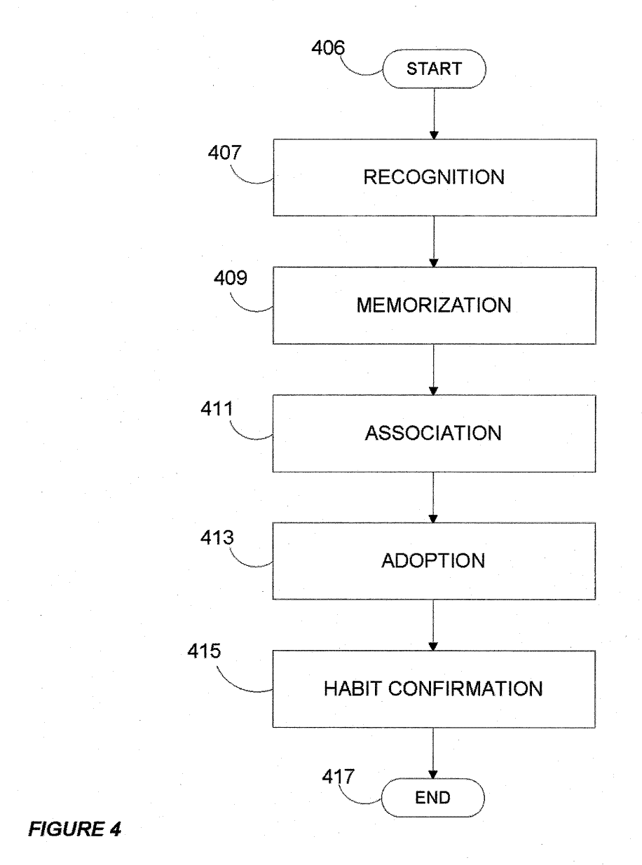

Operationally, the secure intelligent network is a machine learning environment that implements a process having several steps which are shown in FIG. 4. After commencing operation (step 406), the network actively monitors user interactions to identify those interactions that can be recognized by as shown in step 407. Once actions or patterns of actions are identified and recognized the network will build an active user profile and memorize certain actions as shown at step 409 that can be used to analyze associations among data produced as a byproduct of the interactions monitored by the system. The analysis involves the formation of associations among the data identified by the system as shown at step 411. Once data has been associated and categorized, the network will access or perform a process to determine whether certain actions may be deemed adopted as shown at step 413. If an action or series of actions, events, items are consistent based on long term monitoring, the intelligent network will determine or deduce that such actions are evidence of habits and will confirm certain habits of each user having an account on a device or a set-top box coupled to the network (step 415). Upon completion of these process steps, the network will return to a wait state for additional user interactions, as implied by step 417. This is a process performed by the network as a whole, however, there are several significant sub-processes performed by this network which will be discussed further herein.

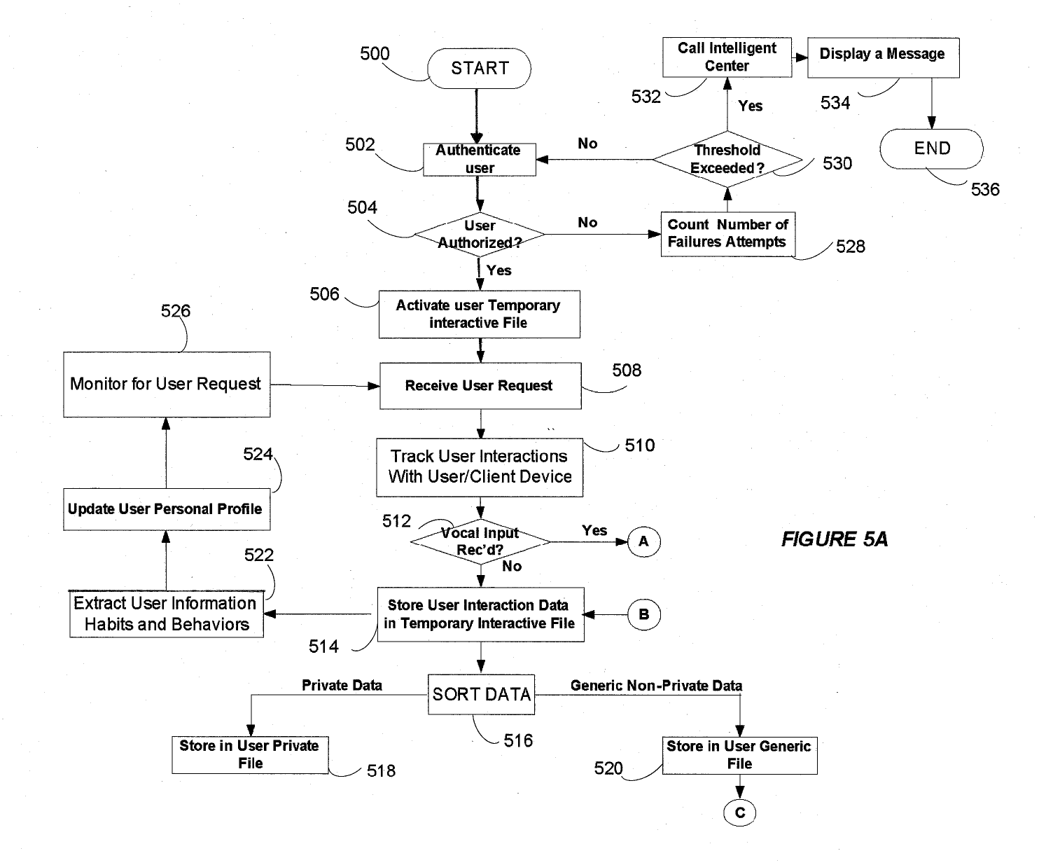

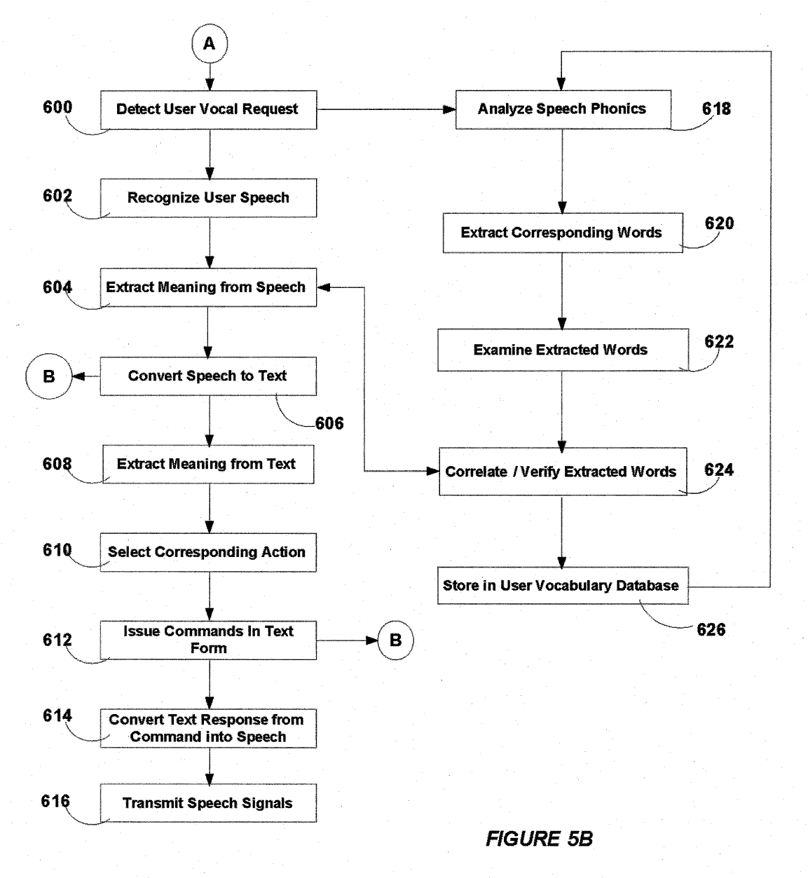

FIG. 5A is an illustration of a flow chart for a process of authenticating a user's identity and monitoring user actions with a device or set-top box within the network. As shown here, a session is initiated (Step 500), the user's identity is authenticated at step 502 and then the user is authorized at step 504. If a user is authorized successfully, a temporary interactive file will be created as shown in step 506 and the system will then actively monitor for a user action or request as shown at step 508. The system actively tracks the user's interactions with a platform that is a separate software sub-system hosted on the set-top box or embedded with a client device and used in the house or location to which the user's device has been assigned. Active tracking of user actions with the platform is a process performed at step 510. The system will then actively monitor for any vocal input or speech input as shown at step 512. If there is no speech input the system will store any user interaction data received from its monitoring process in the temporary interactive file as shown at step 514. The system will then execute a process for extracting user information to determine long term user habits and behaviors as shown at step 522. This process will then produce results that update a user personal profile stored in the system as shown at step 524 and then the system returns to an active monitoring state to monitor for additional user requests as shown at step 526.

Returning to step 504, if a user is not authorized then the system will perform a re-authorization process by first reproducing the authentication procedure at step 502. The system will determine the number of times that it has failed to authorize the user as shown at step 528 and the number of attempts will be compared with a predetermined threshold for authorization attempts as shown at step 530. If that threshold is exceeded, then the set top box at a specific geographic location will initiate a call to an intelligent center as shown at step 532 which is a separate computing resource at each Level One Control and Operation Center 101 (not shown). After transmission of a request to an intelligent call center, a message will be displayed on the set-top box or client enabled device indicating the “authentication has failed” as shown at step 534 and the process of authorizing the user will conclude as shown at step 536.

After storing user interaction data as shown at step 514, a process will be initiated to identify, sort and separate a user's private data from the user's generic non-private data. An important aspect of the operation of the secure and intelligent network is enforced information privacy. No personal identifying information will be transmitted from the set-top box. Only generic non-private data is captured and transferred to successive levels of operational centers in this network. The sorting process shown at step 516 sorts private data from generic non-private data. The private data is stored in a user's private file on a local device or on the local set top box as shown at step 518. The generic non private data, on the other hand, is stored in a user's generic file on a client enabled device or a set-top box as shown at step 520.

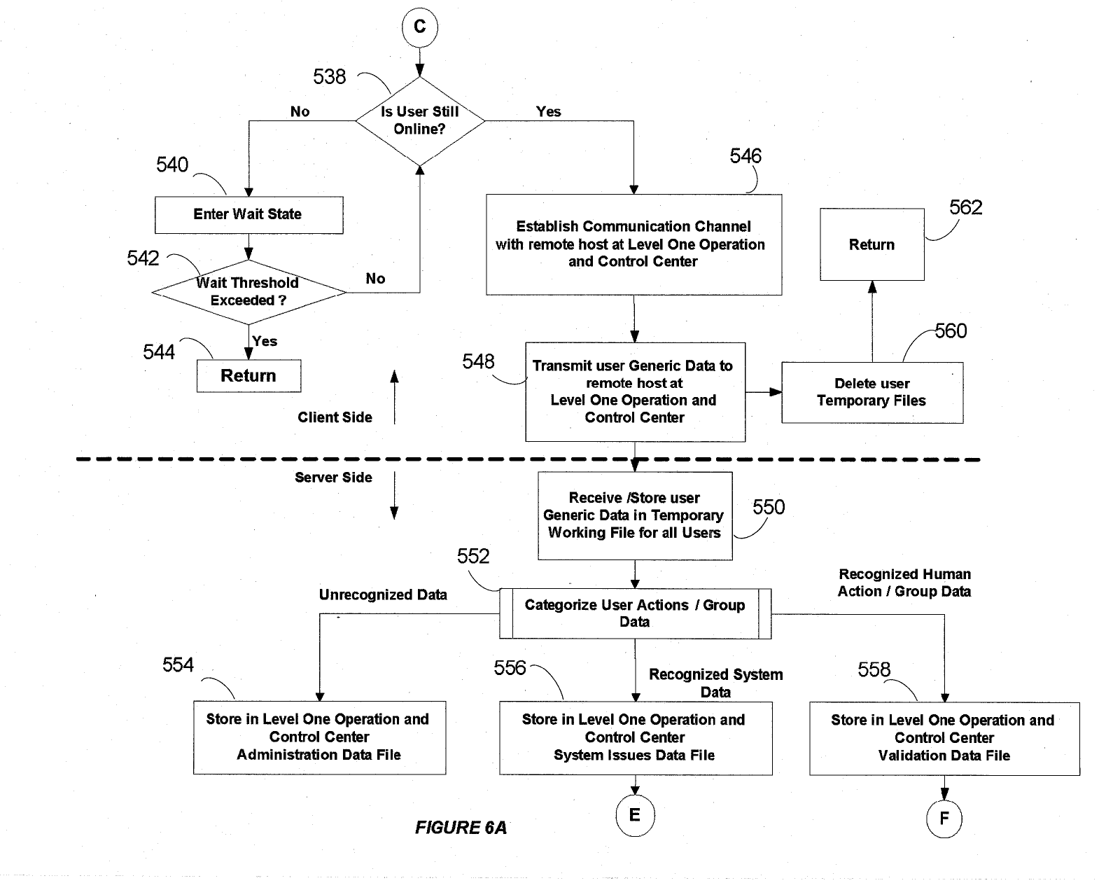

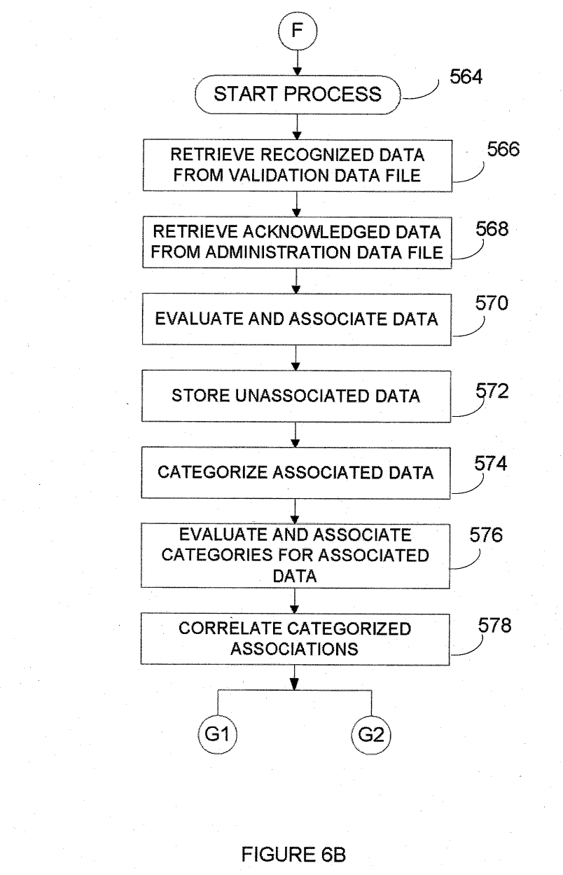

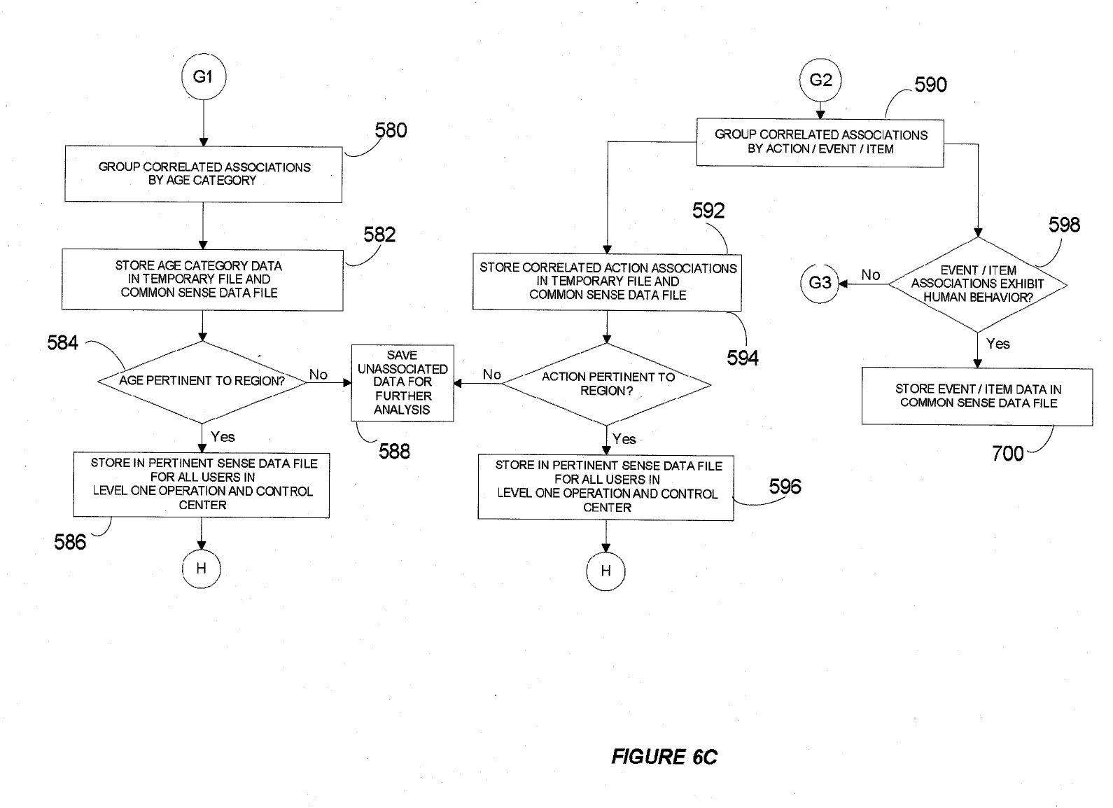

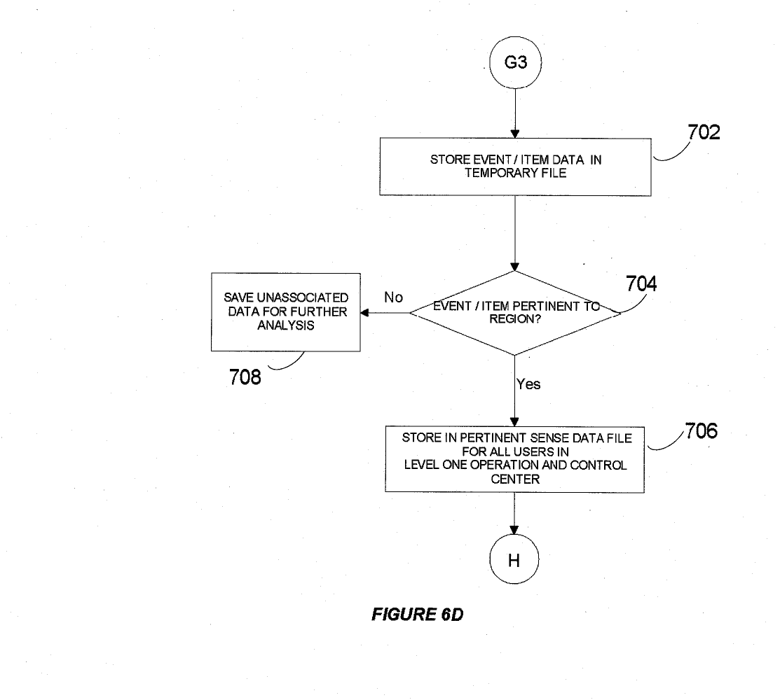

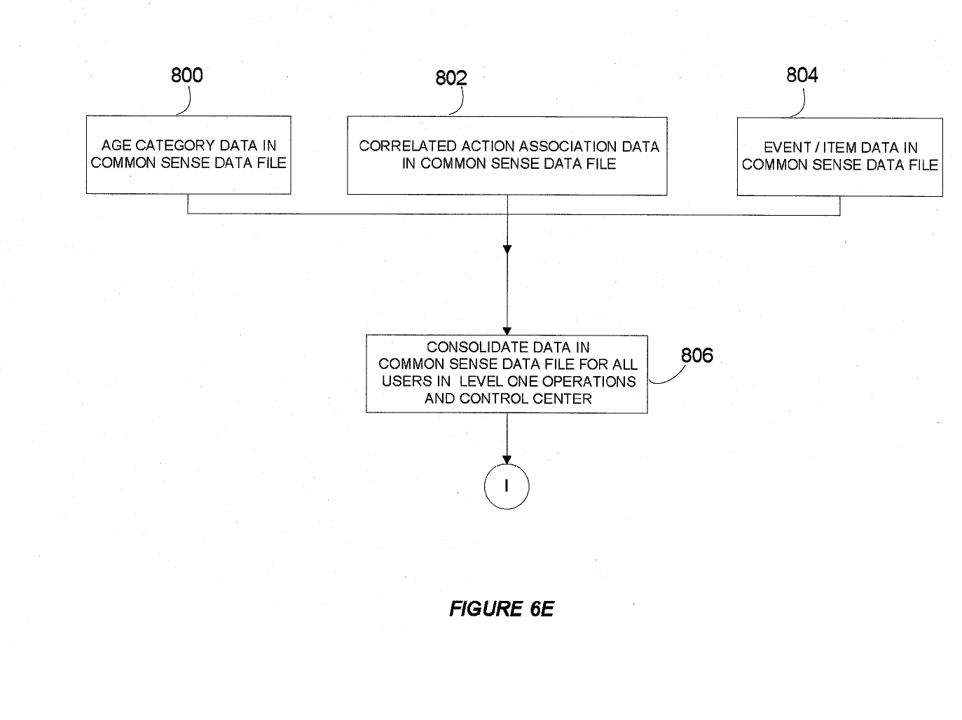

Proceeding now to FIG. 6A, the set top box will attempt to determine at step 538 whether a user is still on-line after actively monitoring a user's interactions. If a user is not on-line then the system will enter into a wait state as shown at step 540 and compare the waiting time with a predetermined wait threshold as shown at step 542. If the threshold is exceeded, then the system will return (step 544). However, if the system has not exceeded the wait threshold then it will continue to actively monitor the client device coupled to the set-top box to determine if a user is on-line as shown at step 538. If a user is on-line, the box will establish a communication channel with its corresponding Level 1 Operation and Control Center 101 as shown at step 546. The generic non private data stored at step 520 will then be transmitted to a Level One Operation and Control Center 101, which data will comprise monitored actions and user group data. Isolation and compartmentalization of private user data occurs at the set-top box and such data remains stored with each user's personal profile as shown at step 524 in FIG. 5A. However, each user is assigned an anonymous identification code that prevents association of the data to an identifiable end user. Thus, in an embodiment the association of an identification code and user data exists only at the set-top box so as to enhance information privacy. A user's group data includes information related to the age category of the user and the events and items related to the actions of the user that were monitored, tracked and transmitted to the Level One Operation and Control Center at step 548. After transmission of the generic non-private data, the content of the user's generic file and the temporary interactive file are deleted as shown at step 560 and the system returns to a wait state, as shown at step 562. In an embodiment, the monitored actions and user group data transmitted at step 548 occurs over at least a dedicated communication channel providing a bandwidth on a privately allocated frequency for each authenticated user using an information compression and encryption process. The transmission of generic data pertaining to the monitored actions and user group data over this communication channel and frequency provide maximum data security even for such generic non-private data. In this way, even such data for authenticated users can remain secure within the operating environment of this global intelligent network.

All of the preceding steps occurred on the client side of this intelligent network (i.e., the location of a set top box or client enabled device). After transmission, a server at the Level 1 Operation and Control Center 101 will receive and store the generic data in a temporary working file that is used for storing data from all users within the geographic region monitored and controlled by that particular Level 1 Operation and Control Center 101, as shown at step 550. The server at the Level 1 Operation and Control Center will commence a process to categorize the user's actions and the group data received, as shown at step 552. This is an important process and is used to categorize data as either recognized or unrecognized. Recognized data is further categorized into data that reflects human actions or human group data or which relates to specific system issues. Unrecognized data is stored in administration data file 115 as shown at step 554. Recognized system data is stored in system issue data file 117 as shown at step 556. Recognized human action and group data is stored in validation data file 119 in Level 1 Operation and Control Center 101, as shown at step 558.

Turning now to FIG. 5B, in the event a vocal input is received as shown at step 512 in FIG. 5A, a process will be initiated to analyze the speech input and determine the nature of the request received. In FIG. 5B, the first step in this process after receipt of vocal input at step 512 involves the detection of a vocal request, as shown at step 600. At step 618, the vocal request is analyzed to determine the speech phonics that are relevant to the input. The speech signal input is further analyzed to extract words that correspond to the speech signal, as shown at step 620 and then these extracted words are compared against an existing database to determine the semantic content of the words, as shown at step 622. The extracted words are then correlated and verified as shown at step 624 and then stored in a vocabulary database, as shown at step 626. Returning now to step 600, after detection of a user's vocal request, in addition to an analysis of the speech phonics as shown at step 618, the speech signal will be processed in an effort to recognize what has been stated by the user, as shown at step 602, and the semantic meaning of the vocalized speech will be analyzed and extracted, as shown at step 604. The extraction of meaning from the speech signal and the correlation and verification of the extracted words as shown at step 624 are performed and a comparison of the results of these two independent processes occurs to improve the accuracy and reliability of the speech detection and analysis process. At step 606, the speech signal is converted into the text and the meaning of the extracted text is further analyzed at step 608. The system will then select a corresponding action as shown at step 610 based on the extracted text and then issue commands in text form as shown at step 612. After issuance of the commands, any text response received from the system will be converted into speech as shown at step 614 and the transmitted speech signal or signals will be transmitted to the user at step 616.

FIG. 6B illustrates a process for analyzing data stored in the validation data file 119 at each Level One Operation and Control Center 101. The process illustrated in this figure is performed at each Level One Operation and Control Center 101 and commences with retrieval of recognized data from validation data file 119, as shown at step 566. Acknowledged data is also retrieved from administration data file 115, as shown at step 568 and then an evaluation of the recognized data and the acknowledged data is performed in an effort establish associations among the data, as shown at step 570. The association process involves the identification of commonalities among data to form clusters of commonly associated data.

An important aspect of the association process involves a determination of which data can or cannot be associated into clusters or groups. Data which cannot be associated is further tested against other received data in order to establish a new association among data. Unassociated data is consistently tested and compared to new data to determine whether new associations or existing associations can be created among data. In the event data cannot be associated, it is stored for further analysis and evaluation, as shown at step 572. Such data will nonetheless continue to be analyzed and be compared for further possible association. Associated data will then be categorized as shown at step 574. The categorization process involves an analysis of the associations among data to identify or generate categorizes that would be relevant to the associated data. Afterwards, the categories of associated data are evaluated to determine if associations among or between categories can be established, as shown at step 576. Thus, categories and associations are an aspect of this process and the system will constantly monitor and access data to determine whether associations can be formed among data and whether categories can be formed among associated data.

After association of categories for the associated data, a correlation process will be performed, as shown at step 578. This process will produce correlations among the various categories of associated data. The results of the correlation process will then be used in two different processes. As shown in FIG. 6C at step 580, a group correlation of associations will be performed by age category. Groups of correlated associations by age category will be produced and stored in a temporary file (not shown) and common data file 122 in the Level One Operation and Control Center 101, as shown at step 582. The age data will be further analyzed as shown at step 584 to determine whether the age data is pertinent to the region monitored by applicable Level One Operation and Control Center 101. In the event the age data is not pertinent to a specific region it will be saved for further analysis as shown at step 588. In the event the age data is pertinent to the region then it will be stored in the pertinent data file 120 for all users in the respective Level One Operation and Control Center as shown at step 586.

In the analysis of the age category data, as shown at step 584, the process will sort and separate data by age and generally categorize data into three distinct categories: Child Category, Teenager Category and Adult Category. The category in which data will be placed is determined from the generic non-private category data previously provided by the set-top box or client enabled device at step 548 in FIG. 6A. Category distinctions are important in an aspect of the method and system because each age category of user data will reflect varying levels of influenced behavior. The Child Category of user data is presumed to reflect data (e.g., actions, events, items) that is reflective of someone who has had the least social exposure and therefore most likely to be indicative of natural, uninfluenced behavior. Such data will be important to the processes performed in the central data repository 401 to be described below that relate to the determination of “common sense” and “pertinent sense.”

Referring now to step 590 for the analysis of group correlated associations by action, event and item, the process will analyze the actions and more specifically the events and items related to the actions that have been monitored by the set top box or client enabled device. Correlated action associations will be stored in a temporary file and a common data file 122 in the Level One Operation and Control Center 101 applicable to the relevant region, as shown at step 592 and then further analysis will be performed on each monitored action to determine if that action is pertinent to the region for the specific Level One Operation and Control Center 101, as shown at step 594. If the action is not pertinent to the region, it will be saved as unassociated data for further analysis as shown at step 588. On the other hand, if the action is pertinent to the region, the monitored action will be stored in a pertinent data file 120 for all users in the relevant Level One Operation and Control Center 101, as shown at step 596. With respect to monitored events and items, after step 590 each associated event or item will be analyzed to determine if it exhibits human behavior that is indicative of human interaction with a device or set top box. In an embodiment of this system there may be events and items which are generated spontaneously or autonomously by the system that are entirely unrelated to human actions with the device. This filtering step is intended to separate those types of events and items that are machine generated and those events and items that are human generated. In the event or item is determined to be related to human behavior, it will be stored in a common data file 122 in the relevant Level One Operation and Control Center 101, as shown at step 700.

In this system an “action” is deemed any specific step or series of steps performed by a human by use of a client enabled device coupled to this network or coupled to a set top box that is itself coupled to the network. Each action will likely have an associated event or item that can be actively monitored by the system. An example of actions monitored by the system would be activations, executions, searches, selections made by the user, downloads of content made by user, activation of software, requests, receipt of information or data and responses produced by such requests, and requests to initiate processes for saving or printing information. Events and items associated with actions may be of various types. One example of an action might be to file a request for a divorce decree, the event would be a divorce and the item would be the decree, and both the divorce event and the decree item would be deemed associations exhibiting human behavior and therefore would be stored in a common data file 122 in a Level One Operation and Control Center 101, as implied by step 700. An action such as a crash of a hard drive or an overheating of a component in a system would be an action that would not exhibit human behavior but would be reflective of machine behavior and would be stored in a temporary working file but not deemed human behavior. This would be the type of monitored action that is stored in a temporary file for correlated action associations, as indicated by step 592.

FIG. 6D is a continuation of the process shown in FIG. 6C for events and items. As shown in step 702, after determining an event or item association does not exhibit human behavior, the monitored event or item is stored in a temporary file and further analyzed to determine if it is pertinent to a particular region as shown in step 704. If the event or item is pertinent to a region then it will be stored in the pertinent data file 120 of the relevant Level One Operation and Control Center 101 covering the region in which this event or item was produced, as shown at step 706. The event or item will be saved with unassociated data for analysis as shown at step 708 if it is determined to be not pertinent to the region covered by the Level One Operation and Control Center 101.

FIG. 6E is a block diagram illustrating the structural relationship between components of the common data file 122 and each Level One Operation and Control Center 101. Common data file 122 is comprised of several different types of data considered to be “common data” as a result of the processes performed and illustrated in FIGS. 6A, 6B and 6C. Age category data 800 stored in common data file 122, and correlated action association data 802 stored in common data file 122, and event/item data 804 stored in common data file 122 are all components of common data stored in each Level Operation and Control Center 101. The consolidated data in the memory of the Level Operation and Control Center 101 as shown in block 806 reflects the consolidation of data in common data file 122 for all users in each Level One Operation and Control Center 101. This data will then be transmitted upon request to the corresponding Level Two Operation and Control Center 201 and higher succeeding layers of the secure and intelligent network, as implied by the flow chart shown in FIG. 7.

FIG. 7 shows a flow chart illustrating the flow of data from the lowest level at each Level One Operation and Control Center 101 to the highest level in this worldwide secure and intelligent network. As shown in step 830, pertinent data for all users for each Level One Operation and Control Center 101 is stored and consolidated. Likewise, all data in common data files for all users at each Level One Operation and Control Center 101 is stored and consolidated as show in step 808. The system data recognized by the process performed at step 552 in FIG. 6A is stored in the system issues data file 117 in each Level One Operation and Control Center 101. All such data will then be analyzed by a trouble shooting process, shown at step 828 in FIG. 7.

Continuing now with pertinent data, a data integrity and information extraction process 832 will be applied to all stored pertinent data in each Level One Operation and Control Center. This process involves additional analysis and associations of data to confirm the pertinence of the data to the region covered by the relevant Level One Operation and Control Center. In one embodiment, the process involves the application of behavioral neuro-scientific analysis to confirm the pertinence of the data. Data which is later deemed not pertinent but merely common will be transferred to common data file 117 in the applicable Level One Operation and Control Center. The pertinent data stored in each of the pertinent data files 120 of each Level One Operation and Control Center controlled by a Level 2 Operation and Control Center 201 will be compiled and stored in the common data file 212 for each Level Two Operation and Control Center. In this way pertinence data from all Level One Operation and Control Centers controlled and operated by each Level Two Operation and Control Center 201 will be compiled and further analyzed for data integrity and information extraction as shown in step 836. The level 2 pertinent data will be further compiled at each Level Three Operation and Control Center 301 as shown in step 838 where an additional data integrity and information extraction process will be performed as shown in step 840. Ultimately, the pertinent data will be compiled from all Level Three Operation and Control Centers 301 in a pertinent data file 403 in the central data repository 401, as shown in step 842.

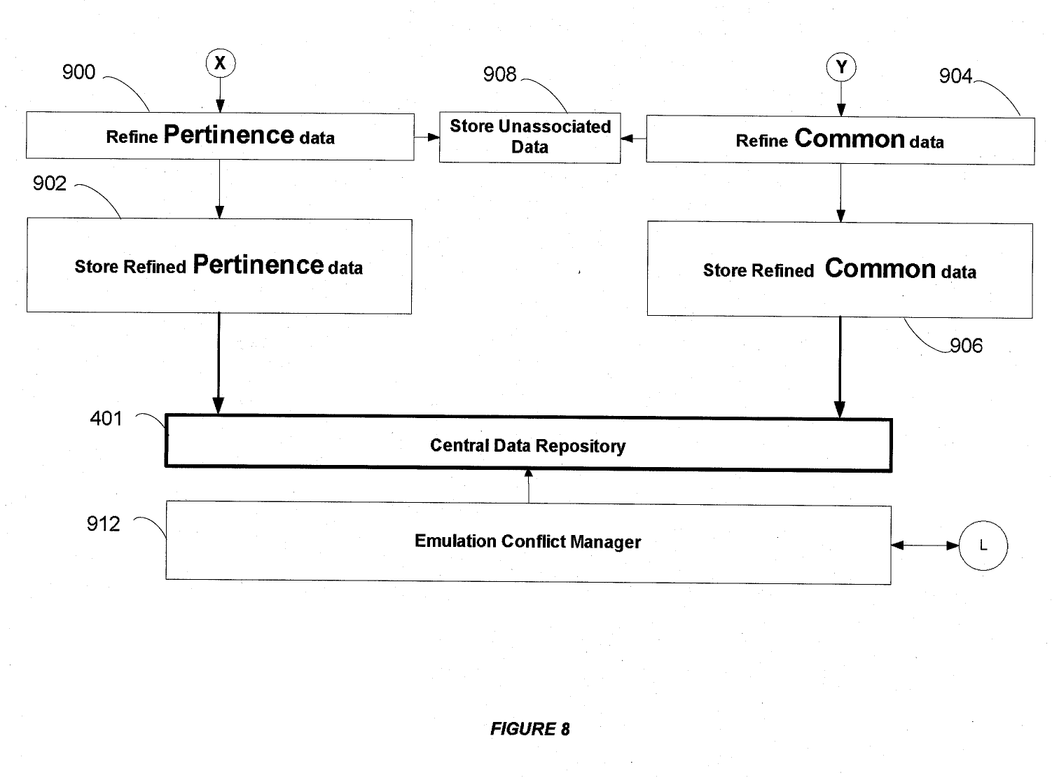

Returning now to step 808, after storing all common data for all users at each Level One Operation and Control Center 101, a process is performed to insure data integrity and to extract relevant information as shown in step 810. This process continues to analyze common data to determine whether it is relevant or pertinent to only particular regions or particular devices monitored by a particular Level One Operation and Control Center 101. If data is later deem to be pertinent only to a particular region or geographic area it will be transferred to the pertinent data file 120 for the relevant Level One Operation and Control Center. In addition the common data and the pertinent data generated and stored in each Level One Operation and Control Center 101 will be used as inputs to an autonomously generated and executed emulation which emulates human behavior, as shown in step 812. This emulation will be generated and executed on each Level One Operation and Control Center and to the extent processing or logical conflicts arise between the emulations they will be resolved by emulation conflict manager 912, shown in FIG. 8.

After storage of common data at each Level One Operation and Control Center 101, each Level Two Operation and Control Center 201 will compile and aggregate all level 1 common data across all Level Operation and Control Centers 101 controlled by each respective Level Two Operation and Control Center 201, as shown in step 816. A data integrity and information extraction process will be performed at this stage, as shown in step 814, to extract meaning from the information and data compiled from all Level One Operation and Control Centers 101 and to confirm the integrity of the data. All level two data will be further compiled at each Level Three Operation and Control Center 301 as shown in step 822. This data will be further analyzed by the data integrity and information extraction process shown in step 820 to enhance the quality of the data received at that level. Again, emulations will be generated and executed that emulate human behavior based on the available data at each level of operation. As shown in step 818, a human emulation will be generated and executed based on available data at each Level Two Operation and Control Center 201. These emulations will monitor activities performed by users in each of the regions covered by these operation and control centers and provide feedback to users as necessary to insure the responsive operation of the network to the needs of each user. Emulations will be generated based on data available at the Level Three Operation and Control Centers 301 that will be used to provide feedback to the Level Two Operation and Control Centers and to resolve conflicts across emulations executed by those centers, as shown at step 824. At the highest level of aggregation of common data, all level three data files are compiled at step 826 in the central data repository 401.

As shown in FIG. 8, after compilation of all level three pertinent data files at step 842, a process will be performed in the central data repository 401 to refine all received pertinent data as shown at step 900. Unassociated data will be identified and stored in an intermediate data store for unassociated data as shown at step 908. Likewise, all common data compiled by the central data repository 401 will be refined as shown at step 904 and unassociated data will be transferred to the unassociated data store as shown at step 908. In an embodiment, the data compiled in the central data repository 401 will be refined by applying behavioral neuro-scientific techniques. Refined pertinent data will later be stored as shown at step 902 in the data repository 401 and more specifically in the pertinent data file 403. The refined common data produced by step 904 will be stored as shown at step 906 in the common data file 405 of the central data repository 401. The emulation conflict manager 912 will also update and store data relating to common sources of conflicts among the human behavior emulations executed by the operations and control centers 101, 201 and 301. In an embodiment, the emulation conflict manager 912 is used primarily for the purpose of resolving conflicts and solving indeterminate problems among these emulations. Such common conflict data will be stored in issues data file 404 in central data repository 401.

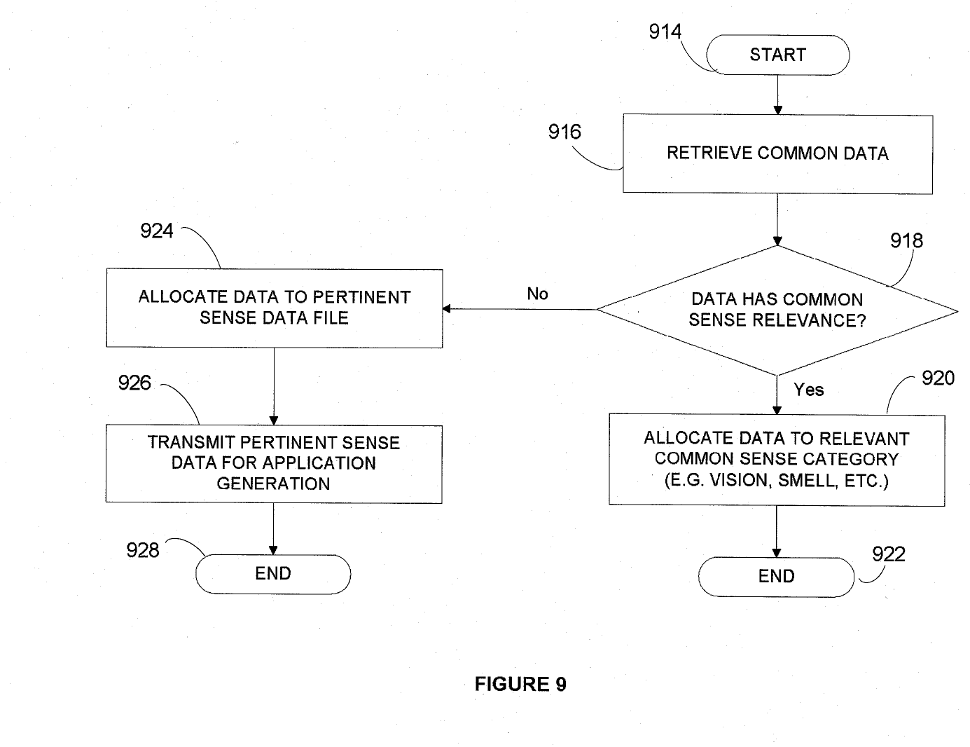

The central data repository 401 will initiate a process to further refine commonsense data into specific sensory categories. As shown in the FIG. 9, this process starts at step 914 and involves the retrieval of common data from common data file 405, as shown at step 916 and the application of an analysis process to that data to determine whether the data has common sensory relevance, as shown at step 918. If the data does have contain common sensory relevance, then it will be allocated to a specific sensory category such as vision, smell, taste, etc. as shown at step 920. After the allocation, the process comes to a completion and awaits the receipt of additional common data (step 922). Returning to step 918, if common sensory relevance information is not included in the data, then the system will allocate the data to the pertinent data file 403, as shown at step 924. It is important to note that only after this further analysis of common data for a sensory relevance can data be considered “pertinent sense” data. Each preceding level in this secure and intelligent network provided for storage of pertinent data, but such data is not deemed to be of a type “pertinent sense” until it is further analyzed by this process executed in the central data repository 401. After allocation of data to the pertinent sense data file, the pertinent sense data will be transmitted as shown at step 926 for the generation of an application specific to the needs of a user based on the analysis of that user's behaviors and habits. After transmission of this data, this process returns to a wait state as shown at step 928.

Throughout this disclosure, “common sense” behavior has been considered to be deemed common throughout the world or to a group of users who use devices and/or set top boxes that are coupled to the secure and intelligent network. On the other hand, “pertinent sense” behavior is deemed to be relative only to specific regions including users who use devices or set top boxes coupled to the secure and intelligent network that demonstrate behavior such as actions, events and items that are common only to a specific geographic region or multiple geographic regions controlled by a particular operation and control center. As shown above, the system and methods disclosed herein provide significant advantages by enabling a true artificial intelligence to develop and derive common sense and pertinent sense from limited information provided from the monitoring of user interactions with enabled devices and set top boxes in a manner that permits secure data gathering with full and undirected interaction with these users.

In addition, communication between boxes and operations and control centers occurs on privately allocated transmission frequencies to maximize data security. Information privacy is maximized by preventing all personal user information from being transmitted from any device or set top box to any operation and control center. Only actions and generic user group data will be transmitted from set-top boxes or enabled devices to operations and control centers on the privately allocated communication frequencies. Thus the methods and system disclosed herein provides for maximum information privacy, data security and significant application scalability driven only by the cost of deployment of the set-top boxes or devices. User actions that are monitored by the operation and control centers are contained within the secure and intelligent network and individuals external to this network (i.e. those who do not have enabled devices or set-top boxes) cannot interact with any resources provided on the secure and intelligent network. In this way, the secure and intelligent network can preserve and enforce worldwide privacy and security policies while insuring full user functionality and adaptability of the system to each user's needs.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A system operative to implement a secure self-contained network, the system comprising:
a plurality of operation and control centers comprising the secure self-contained network;
a plurality of client devices coupled to the operation and control centers, each client device operative to monitor user actions and to compile data based on the actions; and
a data repository coupled to the plurality of operation and control centers, at least a first group of the plurality of operation and control centers operative to categorize the compiled data based on the monitored user actions, the data repository operative to determine the relevance of the compiled data.

2. The system of claim 1 wherein each client device includes a controllable access restriction, the controllable access restriction providing access to the secure, self-contained network.

3. The system of claim 1 wherein each client device is coupled to a controllable access restriction device, the controllable access restriction device providing access to the secure, self-contained network.

4. The system of claim 2 wherein the controllable access restriction is operative to implement a reciprocal access control restriction.

5. The system of claim 3 wherein the controllable access restriction device is operative to implement a reciprocal access control restriction.

6. The system of claim 2 wherein the controllable access restriction is controlled from one or more of the plurality of operation and control centers comprising the secure, self-contained network.

7. The system of claim 2 wherein the controllable access restriction is controlled from one or more servers external to the secure, self-contained network.

8. The system of claim 3 wherein the controllable access restriction device is controlled from one or more of the plurality of operation and control centers comprising the secure, self-contained network.

9. The system of claim 3 wherein the controllable access restriction device is controlled from one or more servers external to the secure, self-contained network.

10. The system of claim 1 wherein the plurality of client devices comprises at least one of a television, a desktop computer, a portable computer, a smart phone, a personal digital assistant, a set-top box and an audiovisual streaming device.

11. The system of claim 10 wherein each of the plurality of client devices is comprised of an embedded custom module, the custom module operative to provide users restricted access to the plurality of operation and control centers.

12. The system of claim 10 wherein one or more of the plurality of client devices is comprised of a specially-adapted general-purpose module, the specially-adapted general-purpose module operative to provide user restricted access to the plurality of operation and control centers.

13. The system of claim 10 wherein the audiovisual streaming device comprises one of a DVD player and a video gaming platform.

14. The system of claim 1 wherein each of the plurality of operation and control centers at least one server device operative to sort the compiled data into a first data group and a second data group, the first data group comprising common sense data and the second data group comprising pertinent sense data.

15. The system of claim 1 wherein the plurality of operation and control centers further comprises a second group of operation and control centers and a third group of operation and control centers, the second group operative to compile and refine the compiled data based on the categorized monitored user actions of the first group, the third group operative to compile and refine the compiled data of the second group.

16. The system of claim 1 wherein the data repository is further coupled to an emulation manager, the emulation manager operative to generate and execute at least one emulation manager for the plurality of operation and control centers.

17. The system of claim 15 wherein the data repository is further coupled to an emulation manager, the emulation manager operative to generate and execute at least one emulation for the first group, the second group and the third group.

18. A method for determining the relevance of data associated with user actions, the method comprising:
monitoring the user actions at a plurality of user devices coupled to a secure, self-contained network, the user actions generating a plurality of data based on the actions;
compiling the plurality of data in a plurality of operation and control centers comprising the secure, self-contained network;
forming associations between the plurality of compiled data;
categorizing the associations formed from the compiled data; and
correlating the categorized associations into a plurality of relevance groups.

19. The method of claim 18 wherein the plurality of operation and control centers are distributed across a plurality of geographical regions.

20. The method of claim 18 wherein the plurality of data generated from the user actions comprises common sense data and pertinent sense data.

21. The method of claim 18 wherein the compiling of the plurality of data comprises sorting the data into a first data group and a second data group in a first group of the plurality of operation and control centers, the first data group including common sense data and the second data group including pertinent sense data.

22. The method of claim 21 wherein the first group of the plurality of operation and control centers are distributed across a plurality of geographic regions, the first data group includes common sense data compiled according to each of the plurality of geographic regions and the second data group includes pertinent: sense data compiled according to each of the plurality of geographic regions.

23. The method of claim 18 wherein the plurality of operation and control centers comprise at least a first group of operation and control centers, a second group of operation and control centers and a third group of operation and control centers, the plurality of user devices coupled to the first group of operation and control centers, each of the first group, the second group and the third group including an emulation manager for generating and executing an emulation for each of the first group, the second group and the third group.

24. The method of claim 23 wherein the emulation manager executes the emulation for each of the first group, the second group and the third group based on the plurality of compiled data, the plurality of compiled data including a first data group comprising common sense data and a second data group comprising pertinent sense data.

25. The method of claim 24 wherein the emulation manager is operative to execute the emulation for the first group based on the first data group and the second data group compiled for the first group.

26. The method of claim 24 wherein the emulation manager is operative to execute the emulation for the second group based on the first data group and the second data group compiled for the second group.

27. The method of claim 24 wherein the emulation manager is operative to execute the emulation for the third group based on the first data group and the second data group compiled for the third group.

28. The method of claim 18 wherein a data repository is coupled to the plurality of operation and control centers, the data repository operative to store a plurality of pertinent sense data and a plurality of common sense data based on the plurality of data generated from the monitoring of the user actions.

29. A computer-readable medium having instructions for performing the method comprising:
monitoring the user actions at a plurality of user devices coupled to a secure, self-contained network, the user actions generating a plurality of data based on the actions;
compiling the plurality of data in a plurality of operation and control centers comprising the secure, self-contained network;
forming associations between the plurality of compiled data;
categorizing the associations formed from the compiled data; and
correlating the categorized associations into a plurality of relevance groups.

30. The computer-readable medium of claim 29 wherein the plurality of operation and control centers are distributed across a plurality of geographical regions.

31. The computer-readable medium of claim 29 wherein the plurality of data generated from the user actions comprises common sense data and pertinent sense data.

32. The computer-readable medium of claim 29 wherein the compiling of the plurality of data comprises sorting the data into a first data group and a second data group in a first group of the plurality of operation and control centers, the first data group including common sense data and the second data group including pertinent sense data.

33. The computer-readable medium of claim 32 wherein the first group of the plurality of operation and control centers are distributed across a plurality of geographic regions, the first data group includes common sense data compiled according to each of the plurality of geographic regions and the second data group includes pertinent sense data compiled according to each of the plurality of geographic regions.

34. The computer-readable medium of claim 29 wherein the plurality of operation and control centers comprise at least a first group of operation and control centers, a second group of operation and control centers and a third group of operation and control centers, the plurality of user devices coupled to the first group of operation and control centers, each of the first group, the second group and the third group including an emulation manager for generating and executing an emulation for each of the first group, the second group and the third group.

35. The computer-readable medium of claim 34 wherein the emulation manager executes the emulation for each of the first group, the second group and the third group based on the plurality of compiled data, the plurality of compiled data including a first data group comprising common sense data and a second data group comprising pertinent sense data.

36. The computer-readable medium of claim 35 wherein the emulation manager is operative to execute the emulation for the first group based on the first data group and the second data group compiled for the first group.

37. The computer-readable medium of claim 35 wherein the emulation manager is operative to execute the emulation for the second group based on the first data group and the second data group compiled for the second group.

38. The computer-readable medium of claim 35 wherein the emulation manager is operative to execute the emulation for the third group based on the first data group and the second data group compiled for the third group.

39. The computer-readable medium of claim 29 wherein a data repository is coupled to the plurality of operation and control centers, the data repository operative to store a plurality of pertinent sense data and a plurality of common sense data based on the plurality of data generated from the monitoring of the user actions.
